(19) United States
(12) Patent Application Publication
(10) Pub. No.: US 2006/0163296 A1
(43) Pub. Date: Jul. 27, 2006

(54) Load carrier

(76) Inventor: Michael B. McMillan, Caldwell, ID (US)

Correspondence Address: ROBERT L. SHAVER;DYKAS, SHAVER & NIPPER, LLP, PO BOX 877, BOISE, ID, 83701-0877, US

(21) Appl. No.: 11/046,078

(22) Filed: Jan. 27, 2005

(51) Int. Cl. B60R 9/00

(52) U.S. Cl. 224/319; 224/328

(57) ABSTRACT

A load carrier for attachment to a vehicle roof that includes a flat and solid floor panel with attached sides. One side is positioned at an angle, and forms a wind deflector for the load carrier. The invention includes storage components and attachments for sporting equipment such as skis, boats, bicycles, and storage containers.

### BACKGROUND OF THE INVENTION

1. Field of the Invention

The present invention generally relates to a load carrier to be mounted on a vehicle roof, and more specifically the invention is a load carrier that has a solid floor and four side walls, with one side wall forming a wind deflector for positioning towards the front of the vehicle.

2. Background Information

There are a number of situations in which loads need to be attached to a carrier on the roof of a vehicle. This can be when transporting luggage, equipment, and sporting gear, such as skis, bikes, kayaks, canoes, surfboards, windsurfing equipment, backpacks, boxes or bags that contain other articles. Over the years a number of roof rack styles have been created. Some are open structures in more or less a basket configuration. These can have wire sides or tubular or rod pieces that are joined together to form a basket like open top structure. This type of container usually has four walls and a floor all made in the form of a basket.

Another type of container that has developed is the fully enclosed box, which is generally a shell with a bottom half and a top half, with the top half hinging open to allow access to the inside of the box.

Other load carrying devices have been developed that include bars that mount on feet, with the feet attaching to the gutter or gutter area of a vehicle. A number of different types of transporting containers, including the wire basket described above, the enclosed box described above, and specialized attachments for skis, bikes, canoes, kayaks, surfboards and sailboards, may be placed on the racks.

The cargo carriers described above have certain limitations and a different type of cargo carrier would fill a need for some people. That cargo carrier would have a flat floor, which is generally solid. The flat floor would be surrounded by short side walls, with the front side wall forming a wind deflector. This type of load carrier would be open in configuration and flexible enough in design to allow any number of objects to be carried, including bulky items such as boxes, duffle bags, etc.

Additional objects, advantages and novel features of the invention will be set forth in part in the description which follows and in part will become apparent to those skilled in the art upon examination of the following or may be learned by practice of the invention. The objects and advantages of the invention may be realized and attained by means of the instrumentalities and combinations particularly pointed out in the appended claims.

### SUMMARY OF THE INVENTION

The load carrier of the invention is configured for attachment to a vehicle roof. Such a vehicle would typically be a vehicle on which load bars are already attached. These might be load bars made for attachment to vehicles for cargo systems, or they may be the factory installed load bars that come with many vehicles. The device includes a load carrier body that is attachable to the load bars of the vehicle. The load carrier body is made of a generally contiguous and flat or planar floor panel. Attached to the floor panel are a left and right side wall, a rear end wall, and a front end wall. The front end wall is configured to act as a wind deflector. Each of the side walls is attached to one of the edges of the planar floor panel, and they are attached to each other where the walls abut one another. The load carrier also has securing means for securing objects to be placed in the load carrier.

The load carrier of the invention has a number of advantages over prior art systems. The basket type carriers are made of a plastic covered wire mesh, which is not sturdy enough to serve as a point of attachment for rack components, such as ski carriers and bike carriers. The wire is also subject to cracking of the plastic covering, which exposes the metal to rusting. The basket designs also do not have an integral wind deflector, but must use an add-on unit, which requires additional parts and complexity. By contrast, the rack of the invention is inherently aerodynamic, as the wind deflector is built-in. The basket type racks are also harder to load and do not protect the roof of the vehicle from the cargo, which might extend through the mesh (bike pedals, kickstands, straps from packs), being carried.

Other prior art systems provide load bars to which a selection of specific use components are attached, such as a bike carrier, ski carrier, and board carriers. In one season, you must remove all the components and put on the bike carriers. In another season, you must remove the bike carriers and install the ski carriers. Since the components sometimes must feed over the bars from the end, this can be a big job and not something you want to do more than once per season. Thus, the prior art racks cannot be quickly modified for different gear. If parts of any of the attachment components are lost, the components may sit idle for years until replacement parts are found. The rack of the invention addresses these shortcomings with a flexible system that can be used for different types of gear to be carried, without changing component systems.

The securing means can include any number of conventional securing means, including straps, buckles, ropes, nets, attachment brackets, clamps, and other conventional means of attachment.

The load carrier is configured for attachment to the load bars by a number of means. The load carrier can attach to the load bars by straps that pass through holes in the load carrier body and around the load bars. The load carrier can also attach to load bars by means of U-bolt attachments, with a U-bolt passing on either side of the bar and extending into the interior of the load carrier for securement by bolts, clamps or other devices. The load carrier can also attach to the load bars by one or more clamps that secure the load carrier to the load bars.

The front end wall serves as a wind deflector by being joined to the load carrier body at an acute angle, such as approximately a 45 degree angle. The walls of the load carrier can be of a number of heights, but a general height range is approximately four to fourteen inches. The left and right side walls would typically be mounted perpendicular or normal to the planar floor panel of the load carrier body, but could also be attached at an angle. This could be an acute angle sloping inward towards the center of the planar floor panel. Similarly, the rear wall could be normal to the planar floor panel or it could be mounted at an angle sloping towards the center of the floor panel.

The load carrier of the invention can include drain holes for allowing water to drain from the planar floor panel. It can also include means for tying the cargo down, such as locations for straps, attachment points for nets, and attachment points for ropes, cords, and bungee cords. Cargo tie down attachments can be located on the carrier body or can be holes located in the carrier body through which tie downs are passed. One type of cargo tie down includes straps and locks that are located on the ends of the straps, which are passed over cargo and used to tie the cargo down.

The load carrier of the invention can also include cargo containers that fit within the load carrier, and together form a load carrying system. The load carrying system of the invention can also include removable attachment devices for various kinds of sports equipment, including ski carrier attachments, bicycle carrier attachments, board carrier attachments, and water craft attachments.

The purpose of the foregoing Abstract is to enable the United States Patent and Trademark Office and the public generally, and especially the scientists, engineers, and practitioners in the art who are not familiar with patent or legal terms or phraseology, to determine quickly from a cursory inspection, the nature and essence of the technical disclosure of the application. The Abstract is neither intended to define the invention of the application, which is measured by the claims, nor is it intended to be limiting as to the scope of the invention in any way.

Still other objects and advantages of the present invention will become readily apparent to those skilled in this art from the following detailed description wherein I have shown and described only the preferred embodiment of the invention, simply by way of illustration of the best mode contemplated by carrying out my invention. As will be realized, the invention is capable of modification in various obvious respects all without departing from the invention. Accordingly, the drawings and description of the preferred embodiment are to be regarded as illustrative in nature, and not as restrictive in nature.

### BRIEF DESCRIPTION OF THE DRAWINGS

FIG. 1 is a perspective view of the roof rack of the invention.

FIG. 2 is a side view of the roof rack of the invention, mounted on load bars.

FIG. 3 is a side cut away view of the roof rack of the invention, with a bicycle mount.

FIG. 4 is a side cross-sectional view of part of the roof rack, showing attachment to the load bar.

FIG. 5 is a side view of part of the roof rack of the invention showing a U-clamp connection to the load bar.

FIG. 6 is a side cross-sectional view of the roof rack of the invention showing a ski attachment.

FIG. 7 is a side cross-sectional view of the roof rack with a cover.

### DESCRIPTION OF THE PREFERRED EMBODIMENTS

While the invention is susceptible of various modifications and alternative constructions, certain illustrated embodiments thereof have been shown in the drawings and will be described below in detail. It should be understood, however, that there is no intention to limit the invention to the specific form disclosed, but, on the contrary, the invention is to cover all modifications, alternative constructions, and equivalents falling within the spirit and scope of the invention as defined in the claims.

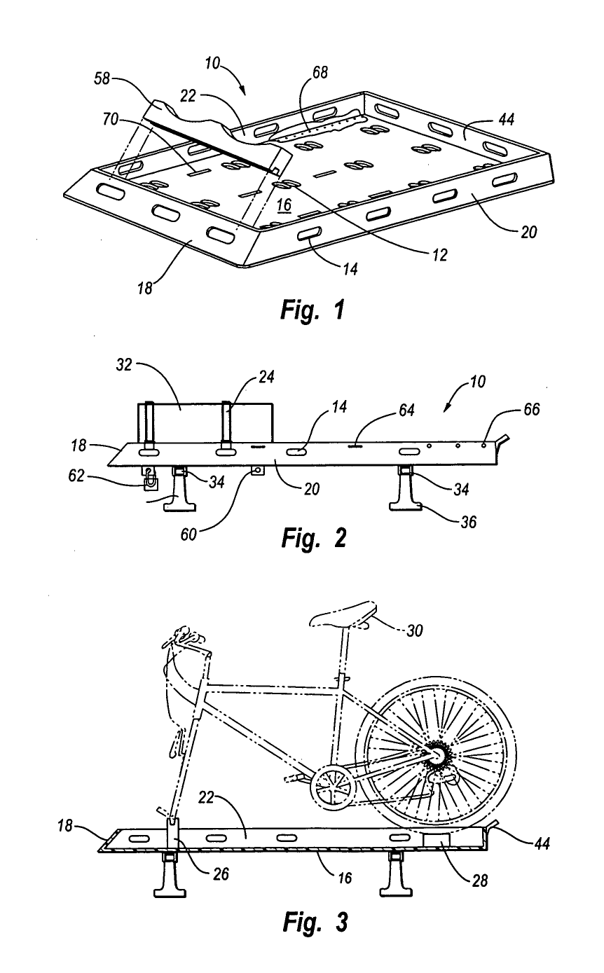

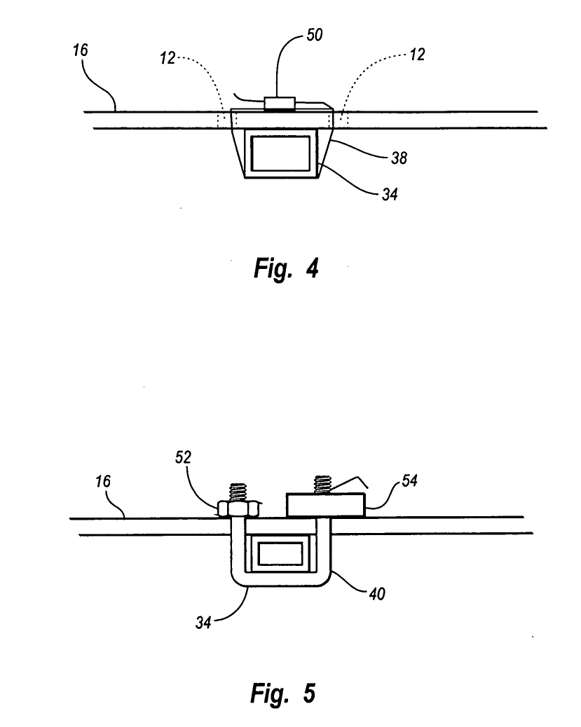

The preferred embodiment of the roof rack of the invention is shown in FIG. 1. It includes a generally planar floor panel 16, a sloping wind deflector 18, a rear wall 44, a left side wall 20, and a right side wall 22. The roof rack can be made from a number of materials, but the preferred material is a high impact plastic of which many different compositions can work. The device could also be made out of other materials such as metal, wood or a plastic with internal metal reinforcement. The roof rack 10 has a floor panel 16 that is generally flat and covers more or less the entire floor of the roof rack 10. The floor panel 16 may have mounting holes 12 positioned thereon. The mounting holes can be large holes such as 12, or smaller holes shown as 68, which can provide a number of mounting positions for U-bolts 40. Drain holes are also present to allow rainwater to drain from the rack. The mounting holes 12 would typically be positioned so that a strap can be passed through a pair of mounting holes 12 and around a load bar 34, as shown in FIG. 4. The holes 68 would be utilized with the U-bolts 40 as shown in FIG. 5.

The wind deflector 18, left side wall 20, right side wall 22, and rear wall 44 may also contain side wall holes 14. These provide points to which cargo can be latched and through which load straps 24 can be passed. The side wall holes can take several configurations, several of which are shown. The slots 64 of FIG. 2 are narrow slots in the side walls through which a strap can pass. The holes 66 of FIG. 2 are holes in the side walls through which bungee cord ends can be secured or additional hooks, snaps, loops or other attachment devices can be attached.

FIG. 2 is a side view of the roof rack 10 of the invention, showing a cargo box 32 secured in place by a pair of load straps 24. Besides the load straps 24, cargo boxes or other complimentary mounting pieces can be secured by other conventional means, such as by nuts and bolts, clamps or by straps. One preferred embodiment of the cargo box 32 includes tabs 60, which fit into slots 70 in the floor of the roof rack. The tabs 60 can protrude to the underside of the roof rack, where they can be secured with a carabiner 62, lock or pin. A long pin can be used to extend through more than one tab 60 for securing one or more cargo boxes 32. The open and unstructured nature of the interior of the roof rack 10 allows large and odd sized articles to be carried on the roof of the vehicle. This can include boxes and bins, and other more or less rectangular objects, as well as oddly shaped objects such as bicycles or other objects that need to be carried. The roof rack 10 of the invention is attached to load bars 34, as shown in FIG. 2. The load bars 34 are mounted on load bar towers 36, which are attached to the vehicle in various ways.

FIG. 3 shows one of many possible types of mounting brackets that can be installed in the roof rack 10. FIG. 3 shows a bike fork mount 26 and a bike rear wheel mount 28, on which is secured a bike 30. Other components include a board/boat bumper 58, shown in FIG. 1. This is a piece that can be added to allow the rack to carry boards (sail, surf), canoes, kayaks or other bulky objects. The bumper 58 fits over the wind deflector and a similar unit fits over the rear wall of the rack to provide a board/boat lifting capacity to the rack.

FIGS. 4 and 5 show two different devices for attaching the roof rack 10 to the load bars 34 of a vehicle. A load bar strap 38 may be used, which passes through a pair of mounting holes 12. The load strap 12 could be secured by a conventional buckle 50 shown or by other securing devices. Shown in FIG. 5 is a load bar clamp 40, which attaches the roof rack 10 to the load bar 34. The clamp 40 may be secured by a conventional nut 52 or it may be secured by an attachment clamp 54.

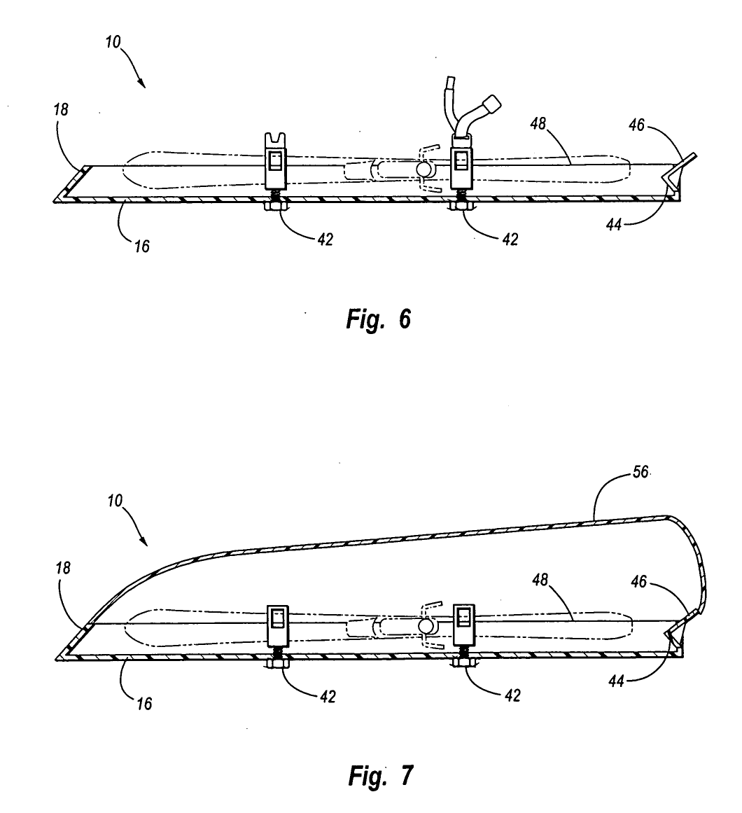

Shown in FIG. 6 is the roof rack 10 of the invention in a cut-away side view. Shown in FIG. 6 is a ski 48 attached to a pair of ski mounts 42. The ski mounts 42 can be attached to the roof rack 10 by a number of different types of devices, including clamps, nuts and bolts, peg and pin, or other types of mountings that makes the ski mounts 42 removable from the floor panel 16 of the invention. One preferred configuration of the ski mounts 42 is a design which is configured to carry skis or to serve as a bike rack, at the option of the user. This capability would allow the user to have one component for these two purposes, and do away with the seasonal rotation of these components. Further, the ski mounts 42 are preferably configured for quick mounting to the floor of the roof rack, by a hand rotating nuts, by a button release and lock, or other quick change features.

FIG. 7 shows another option of the roof rack of the invention; a rack cover 56. This would fit over the side walls, as shown, and latch in place by conventional attachment means.

The invention provides a more flexible system for carrying a variety of load types and shapes, including boxes, interlocking cargo boxes, duffel bags, bikes, skis, boards, boats, packs, suitcases, and other items. Unlike prior art systems, the rack of the invention can carry bikes at the same time as carrying duffel bags and boxes, and can carry a boat, as well as a bike, without switching gear specific components.

While there is shown and described the present preferred embodiment of the invention, it is to be distinctly understood that this invention is not limited thereto but may be variously embodied to practice within the scope of the following claims. From the foregoing description, it will be apparent that various changes may be made without departing from the spirit and scope of the invention as defined by the following claims.

I claim:

1. A load carrier for attachment to a vehicle roof on which load bars are attached, comprising:
a load carrier body configured for attachment to said load bars of said vehicle, comprising a generally contiguous and planar floor panel, a left and right side wall, a rear end wall, and a front end wall configured for wind deflection, with each wall attached along one side to the load carrier body, with said load carrier further comprising securing means for objects to be carried on said load carrier.

2. The load carrier of claim 1 which is configured for attachment to said load bars by straps, through holes defined in said load carrier body.

3. The load carrier of claim 1 which is configured for attachment to said load bars by a plurality of u-bolt attachments to said load bars.

4. The load carrier of claim 1 which is configured for attachment to said load bars by a plurality of clamps.

5. The load carrier of claim 1 in which said load carrier front end wall is configured for wind deflection by being joined to said load carrier body at an acute angle.

6. A load carrier for attachment to a vehicle roof on which load bars are attached, comprising:
a load carrier body configured for attachment to said load bars of said vehicle, comprising a generally contiguous and planar floor panel, a left and right side wall, a rear end wall, and a front end wall configured for wind deflection by being joined to said load carrier body at an acute angle, with each wall attached along one side to the load carrier body, with said load carrier further comprising securing means for objects to be carried on said load carrier.

7. The load carrier of claim 5 in which said front end wall is joined to said load carrier body at approximately 45 degrees.

8. The load carrier of claim 1 in which said walls are approximately 4 to 14 inches tall.

9. The load carrier of claim 5 in which said left and right side walls and said end wall are generally normal to said load carrier body.

10. The load carrier of claim 5 in which said left and right side walls are attached to said load carrier body at an acute angle.

11. The load carrier of claim 10 in which said rear wall is attached to said load carrier body at an acute angle.

12. The load carrier of claim 1 in which rain drain holes are defined in said load carrier body.

13. The load carrier of claim 1, which further includes means for cargo tie down.

14. The load carrier of claim 13 in which said means for cargo tie down are located on said load carrier body.

15. The load carrier of claim 13 in which said means for cargo tie down are located on said walls of said load carrier.

16. The load carrier of claim 13 in which said means for cargo tie down are straps and strap end securing locks.

17. The load carrier of claim 1, which further includes cargo containers for attachment to said load carrier body.

18. The load carrier of claim 1, which further includes removable attachment devices for sports equipment.

19. The load carrier of claim 18 in which said removable attachment devices for sports equipment includes ski carrier attachments.

20. The load carrier of claim 18 in which said removable attachment devices for sports equipment includes bicycle carrier attachments.

21. The load carrier of claim 18 in which said removable attachment devices for sports equipment includes board carrier attachments.

22. The load carrier of claim 18 in which said removable attachment devices for sports equipment includes watercraft attachments.

23. A load carrier for attachment to a vehicle roof, comprising:
a load carrier body configured for attachment to said load bars of said vehicle, comprising a generally contiguous and planar floor panel, a left and right side wall, a rear end wall, and a front end wall configured for wind deflection by being joined to said floor panel at an acute angle, with each wall attached along one side to said floor panel and attached to neighboring walls, with said load carrier further comprising securing means for objects to be carried on said load carrier, and with said floor panel defining a plurality of drain holes, with said load carrier further including means for cargo tie down, and removable cargo containers configured for attachment to said floor panel.

24. The load carrier of claim 23, which further includes removable attachment devices for sports equipment.
